(19) United States
(12) Patent Application Publication
(10) Pub. No.: US 2024/0404195 A1
(43) Pub. Date: Dec. 5, 2024

(54) TRAINING DEVICE, PROCESSING DEVICE, TRAINING METHOD, POSE DETECTION MODEL, AND STORAGE MEDIUM

(71) Applicant: KABUSHIKI KAISHA TOSHIBA, Tokyo (JP)

(72) Inventors: Yasuo NAMIOKA, Nerima Tokyo (JP); Takanori YOSHII, Kawasaki Kanagawa (JP); Atsushi WADA, Yokohama Kanagawa (JP)

(21) Appl. No.: 18/806,164

(22) Filed: Aug. 15, 2024

Related U.S. Application Data
(63) Continuation of application No. PCT/JP2022/006643, filed on Feb. 18, 2022.

(51) Int. Cl. G06T 17/00; G06T 7/70

(52) U.S. Cl. CPC G06T 17/00; G06T 7/70; G06T 2207/30196

(57) ABSTRACT

According to one embodiment, a training device trains a first model and a second model. The first model outputs pose data of a pose of a human body included in a photographed image or a rendered image when the photographed image or the rendered image is input; an actual person is visible in the photographed image; and the rendered image is rendered using a human body model that is virtual. The second model determines whether the pose data is based on one of the photographed image or the rendered image when the pose data is input. The training device trains the first model to reduce an accuracy of the determination by the second model. The training device trains the second model to increase the accuracy of the determination by the second model.

### CROSS-REFERENCE TO RELATED APPLICATIONS

This is a continuation application of International Patent Application PCT/JP2022/006643, filed on Feb. 18, 2022. The entire contents of which are incorporated herein by reference.

### FIELD

Embodiments of the invention relate to a training device, a processing device, a training method, a pose detection model, and a storage medium.

### BACKGROUND

There is technology that detects a pose of a human body from an image. It is desirable to increase the detection accuracy of the pose in such technology.

### BRIEF DESCRIPTION OF THE DRAWINGS

FIG. 1 is a schematic view illustrating a configuration of a training system according to a first embodiment;

FIG. 2 is a flowchart illustrating a training method according to the first embodiment;

FIGS. 3A and 3B are examples of rendered images;

FIGS. 4A and 4B are images illustrating annotation;

FIG. 5 is a schematic view illustrating a configuration of the first model;

FIG. 6 is a schematic view illustrating a configuration of the second model;

FIG. 7 is a schematic view illustrating a training method of the first and second models;

FIG. 8 is a schematic block diagram showing a configuration of a training system according to a first modification of the first embodiment;

FIG. 9 is a schematic block diagram illustrating a configuration of an analysis system according to a second embodiment;

FIG. 10 is a drawing for describing processing according to the analysis system according to the second embodiment;

FIGS. 11A to 11D are figures for describing the processing according to the analysis system according to the second embodiment;

FIGS. 12A to 12D are figures for describing the processing according to the analysis system according to the second embodiment;

FIGS. 13A and 13B are figures for describing the processing according to the analysis system according to the second embodiment;

FIG. 14 is a flowchart illustrating the processing according to the analysis system according to the second embodiment; and

FIG. 15 is a block diagram illustrating a hardware configuration of a system.

### DETAILED DESCRIPTION

According to one embodiment, a training device trains a first model and a second model. The first model outputs pose data of a pose of a human body included in a photographed image or a rendered image when the photographed image or the rendered image is input; an actual person is visible in the photographed image; and the rendered image is rendered using a human body model that is virtual. The second model determines whether the pose data is based on one of the photographed image or the rendered image when the pose data is input. The training device trains the first model to reduce an accuracy of the determination by the second model. The training device trains the second model to increase the accuracy of the determination by the second model.

Embodiments of the invention will now be described with reference to the drawings.

In the specification and drawings, components similar to those already described are marked with the same reference numerals; and a detailed description is omitted as appropriate.

### First Embodiment

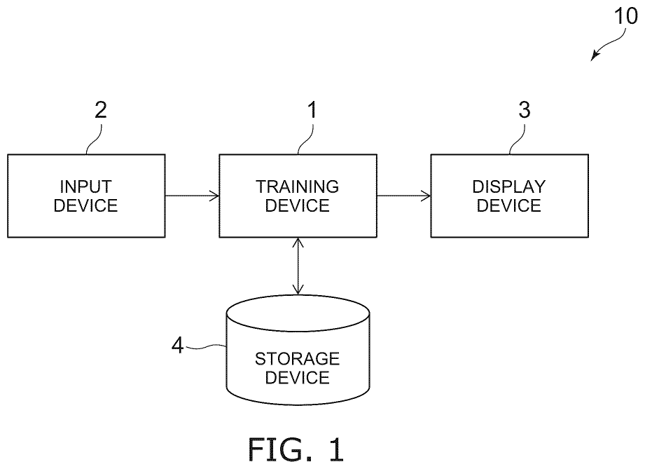

FIG. 1 is a schematic view illustrating a configuration of a training system according to a first embodiment.

The training system 10 according to the first embodiment is used to train a model detecting a pose of a person in an image. The training system 10 includes a training device 1, an input device 2, a display device 3, and a storage device 4.

The training device 1 generates training data used to train a model. Also, the training device 1 trains the model. The training device 1 may be a general-purpose or special-purpose computer. The functions of the training device 1 may be realized by multiple computers.

The input device 2 is used when the user inputs information to the training device 1. The input device 2 includes, for example, at least one selected from a mouse, a keyboard, a microphone (audio input), and a touchpad.

The display device 3 displays, to the user, information transmitted from the training device 1. The display device 3 includes, for example, at least one selected from a monitor and a projector. A device such as a touch panel that functions as both the input device 2 and the display device 3 may be used.

The storage device 4 stores data and models related to the training system 10. The storage device 4 includes, for example, at least one selected from a hard disk drive (HDD), a solid-state drive (SSD), and a network-attached hard disk (NAS).

The training device 1, the input device 2, the display device 3, and the storage device 4 are connected to each other by wireless communication, wired communication, a network (a local area network or the Internet), etc.

The training system 10 will now be described more specifically.

The training device 1 trains two models, i.e., a first model and a second model. The first model detects a pose of a human body included in a photographed image or a rendered image when the photographed image or the rendered image is input. The photographed image is an image obtained by imaging an actual person. The rendered image is an image rendered by a computer program by using a virtual human body model. The rendered image is generated by the training device 1.

The first model outputs pose data as a detection result. The pose data represents the pose of the person. The pose is represented by the positions of multiple parts of the human body. The pose may be represented by an association between the parts. The pose may be represented by both positions of the multiple parts of the human body and associations between the parts. Hereinbelow, information represented by the multiple parts and the associations between the parts also is called a skeleton. Or, the pose may be represented by the positions of multiple joints of the human body. A part refers to one section of the body such as an eye, an ear, a nose, a head, a shoulder, an upper arm, a forearm, a hand, a chest, an abdomen, a thigh, a lower leg, a foot, etc. A joint refers to a movable connecting part such as a neck, an elbow, a wrist, a lower back, a knee, an ankle, or the like that connects at least portions of parts to each other.

The pose data that is output from the first model is input to the second model. The second model determines whether the pose data is obtained based on one of a photographed image or a rendered image.

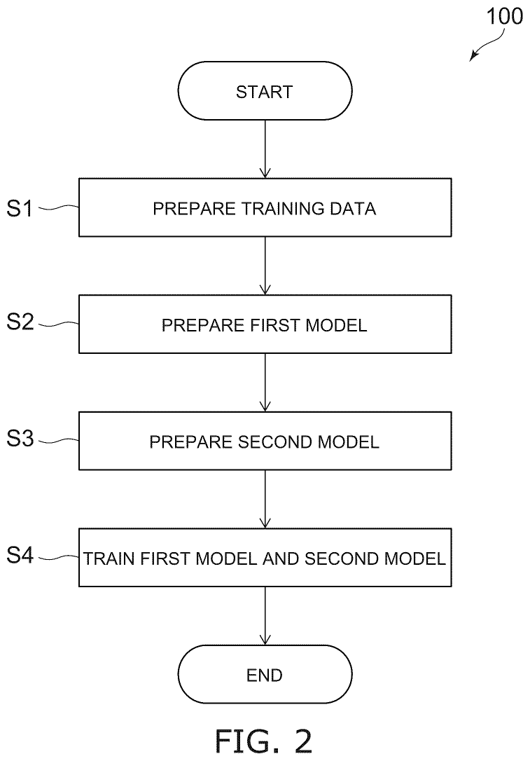

FIG. 2 is a flowchart illustrating a training method according to the first embodiment.

As illustrated in FIG. 2, the training method according to the first embodiment includes preparing training data (step S1), preparing the first model (step S2), preparing the second model (step S3), and training the first and second models (step S4).

### <Preparation of Training Data>

When preparing the photographed image, an image is acquired by imaging a person present in real space with a camera, etc. The entire person may be visible in the image, or only a portion of the person may be visible. Also, multiple persons may be visible in the image. It is favorable for the image to be clear enough that at least the contour of the person can be roughly recognized. The photographed images that are prepared are stored in the storage device 4.

When preparing the training data, preparation of the rendered image and annotation are performed. When preparing the rendered image, modeling, skeleton generation, texture mapping, and rendering are performed. For example, the user uses the training device 1 to perform such processing.

A three-dimensional human body model that models a human body is generated in the modeling. The human body model can be generated using the open source 3D CG software MakeHuman. In MakeHuman, a 3D model of a human body can be easily generated by designating the age, gender, muscle mass, body weight, etc.

In addition to the human body model, an environment model also may be generated to model the environment around the human body. For example, the environment model is generated to model articles (equipment, fixtures, products, etc.), floors, walls, etc. The environment model can be generated by Blender by imaging and using the video image of actual articles, floors, walls, etc. Blender is open source 3D CG software, and includes functions such as 3D model generation, rendering, animation, etc. Blender places the human body model in the generated environment model.

In the skeleton generation, a skeleton is added to the human body model generated in the modeling. A human skeleton called Armature is prepared in MakeHuman. Skeleton data can be easily added to the human body model by using Armature. Motion of the human body model is possible by adding the skeleton data to the human body model and by moving the skeleton.

Motion data of the motion (motion) of an actual human body may be used as the motion of the human body model. The motion data is acquired by a motion capture device. Perception Neuron 2 of Noitom Ltd. can be used as the motion capture device. By using the motion data, the human body model can reproduce the motion of an actual human body.

Texture mapping provides the human body model and the environment model with texture. For example, the human body model is provided with clothing. An image of clothing to be provided to the human body model is prepared; and the image is adjusted to match the size of the human body model. The adjusted image is attached to the human body model. Images of actual articles, floors, walls, etc., are attached to the environment model.

In rendering, the human body model and the environment model that are provided with texture are used to generate a rendered image. The rendered image that is generated is stored in the storage device 4. For example, the human body model is caused to move on the environment model. For example, the human body model and the environment model are rendered from multiple viewpoints at a prescribed spacing while causing the human body model to move. Multiple rendered images are generated thereby.

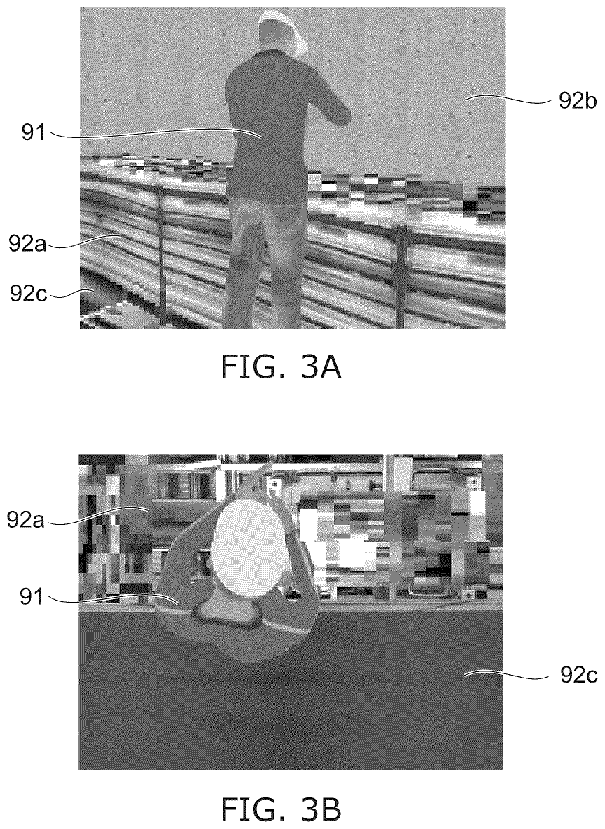

FIGS. 3A and 3B are examples of rendered images.

A human body model 91 with its back turned is visible in the rendered image illustrated in FIG. 3A. In the rendered image illustrated in FIG. 3B, the human body model 91 is imaged from above. Also, a shelf 92a, a wall 92b, and a floor 92c are visible as the environment model. The human body model and the environment model are provided with texture by texture mapping. A uniform that is used in the actual task is provided to the human body model 91 by texture mapping. The upper surface of the shelf 92a is provided with components, tools, jigs, etc., used in the task. The wall 92b is provided with fine shapes, color changes, micro dirt, etc.

In the rendered image illustrated in FIG. 3A, the feet of the human body model 91 are partially cut off at the edge of the image. In the rendered image illustrated in FIG. 3B, the chest, abdomen, lower body, etc., of the human body model 91 are not visible. As illustrated in FIGS. 3A and 3B, rendered images when at least a portion of the human body model 91 is viewed from multiple directions are prepared.

In annotation, data related to the pose is assigned to the photographed image and the rendered image. For example, the annotation format is based on COCO Keypoint Detection Task. In annotation, data of the pose is assigned to the human body included in the image. For example, annotation indicates multiple parts of the human body, the coordinates of the parts, the connectional relationships between the parts, etc. Also, each part is assigned with information of being “present inside the image”, “present outside the image”, or “present inside the image but concealed by something”. An armature that is added when generating the human body model can be used in the annotation for the rendered image.

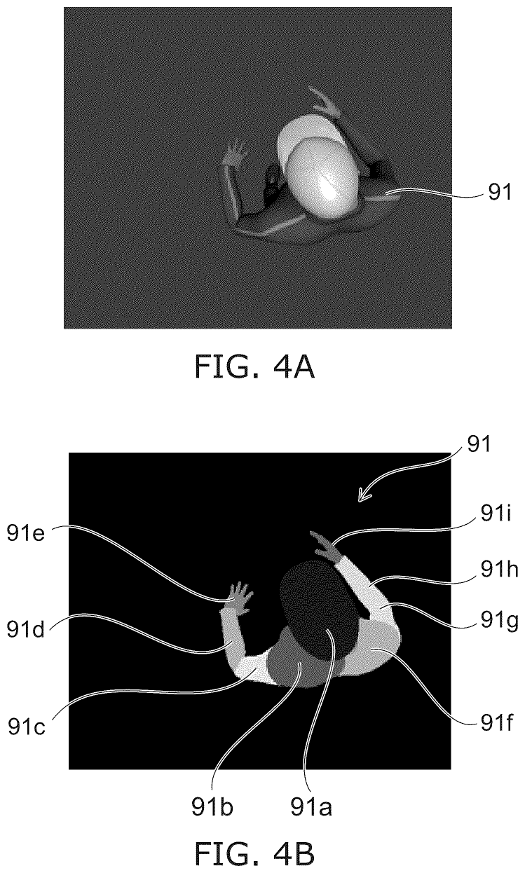

FIGS. 4A and 4B are images illustrating annotation.

FIG. 4A illustrates a rendered image including the human body model 91. An environment model is not included in the example of FIG. 4A. The image to be annotated may include an environment model as illustrated in FIGS. 3A and 3B. As illustrated in FIG. 4B, the parts of the body are annotated for the human body model 91 included in the rendered image of FIG. 4A. The example of FIG. 4B shows a head 91a, a left shoulder 91b, a left upper arm 91c, a left forearm 91d, a left hand 91e, a right shoulder 91f, a right upper arm 91g, a right forearm 91h, and a right hand 91i of the human body model 91.

According to the processing described above, training data includes photographed images, annotation for the that photographed images, rendered images, and annotation for the rendered images is prepared.

### <Preparation of First Model>

The first model is prepared by using prepared training data to train the model in the initial state. The first model may be prepared by acquiring a model that has already been trained using photographed images, and by using rendered images to train this model. In such a case, the preparation of the photographed images and the annotation for the photographed images can be omitted from step S1. For example, the pose detection model, OpenPose, can be utilized as a model trained using photographed images.

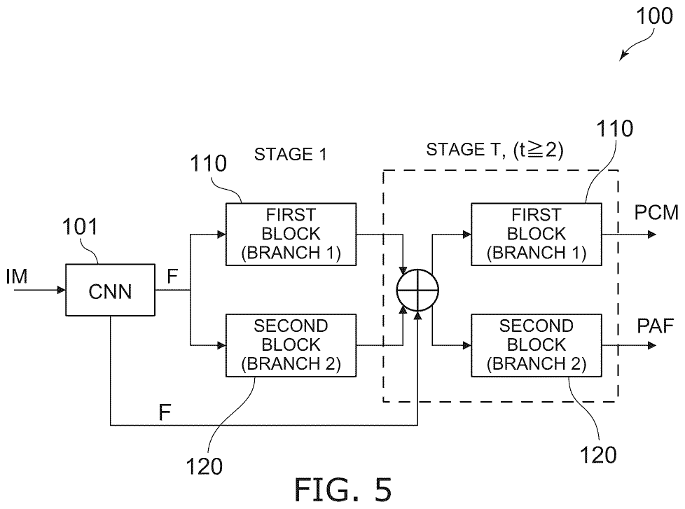

FIG. 5 is a schematic view illustrating a configuration of the first model.

The first model includes multiple neural networks. Specifically, as illustrated in FIG. 5, the first model 100 includes a convolutional neural network (CNN) 101, a first block (a branch 1) 110, and a second block (a branch 2) 120.

First, an image IM that is input to the first model 100 is input to the CNN 101. The image IM is a photographed image or a rendered image. The CNN 101 outputs a feature map F. The feature map F is input to each of the first and second blocks 110 and 120.

The first block 110 outputs a part confidence map (PCM) that indicates the probability that a human body part is present for each pixel. The second block 120 outputs a part affinity field (PAF), which includes vectors representing the associations between the parts. The first block 110 and the second block 120 include, for example, CNNs. Multiple stages that include the first and second blocks 110 and 120 are included, from stage 1 to stage t (t≥2).

The specific configurations of the CNN 101, the first block 110, and the second block 120 are arbitrary as long as the feature map F, the PCM, and the PAF are respectively output. Known configurations are applicable to the configurations of the CNN 101, the first block 110, and the second block 120.

The first block 110 outputs S, which is the PCM. The output of the first block 110 of the first stage is taken as S¹. ρ¹ is taken as the inference output from the first block 110 of stage 1. S¹ is represented by the following Formula 1.

$${S}^{1} = {ρ}^{1} ( F ) \qquad [ Formula 1 ]$$

The second block 120 outputs L, which is the PAF. The output of the second block 120 of the first stage is taken as L¹. ϕ¹ is taken as the inference output from the second block 120 of stage 1. L¹ is represented by the following Formula 2.

$${L}^{1} = {ϕ}^{1} ( F ) \qquad [ Formula 2 ]$$

In stage 2 and subsequent stages, the feature map F and the output of the directly-previous stage are used to perform the detection. The PCM and the PAF of stage 2 and subsequent stages are represented by the following Formulas 3 and 4.

$${S}^{t} = {ρ}^{1} ( F , {S}^{t - 1} , {L}^{t - 1} ) \qquad [ Formula 3 ]$$

$${L}^{t} = {ϕ}^{1} ( F , {S}^{t - 1} , {L}^{t - 1} ) \qquad [ Formula 4 ]$$

The first model 100 is trained to minimize the mean squared error between the correct value and the detected value for each of the PCM and the PAF. The loss function at stage t is represented by the following Formula 5, wherein Sⱼ is the detected value of the PCM of a part j, and S*ⱼ is the correct value.

$${f}_{S}^{t} = {\sum }_{j = 1}^{J} {\sum }_{P}^{} W ( p ) \cdot {‖ {S}_{j}^{t} ( p ) - {S}_{j}^{*} ( p ) ‖}_{2}^{2} \qquad [ Formula 5 ]$$

P is the set of pixels p inside the image. W(p) represents a binary mask. W(p)=0 when the annotation is missing at the pixel p. Otherwise, W(p)=1. By using this mask, an increase of the loss function due to missing annotation when the correct detection is performed can be prevented.

For the PAF, the loss function at stage t is represented by the following Formula 6, wherein L_{c} is the detected value of the PAF at the connection c between the parts, and L*_{c} is the correct value.

$${f}_{L}^{t} = {\sum }_{c = 1}^{C} {\sum }_{P}^{} W ( p ) \cdot {‖ {L}_{c}^{t} ( p ) - {L}_{c}^{*} ( p ) ‖}_{2}^{2} \qquad [ Formula 6 ]$$

From Formulas 5 and 6, the overall loss function is represented by the following Formula 7. In Formula 7, T represents the total number of stages. For example, T=6 is set.

$$f = {\sum }_{t = 1}^{T} ( {f}_{S}^{t} + {f}_{L}^{t} ) \qquad [ Formula 7 ]$$

The correct values of the PCM and the PAF are defined to calculate the loss function. The definition of the correct value of the PCM will now be described. The PCM represents the probability that a part of a human body is present in a two-dimensional planar shape. The PCM has an extremum when a specific part is visible in the image. One PCM is generated for each part. When multiple human bodies are visible inside the image, each part of the human body is described inside the same map.

First, a correct value of the PCM is generated for each human body inside the image. x_{j,k} ∈R² is taken as the coordinate of the part j of the kth person included inside the image. The correct value of the PCM of the part j of the kth human body at the pixel p inside the image is represented by the following Formula 8. σ is a constant defined to adjust the variance of the extrema.

$${s}_{j , k}^{*} ( p ) = exp ( - \frac{{‖ p - {x}_{j , k} ‖}_{2}^{2}}{{σ}^{2}} ) \qquad [ Formula 8 ]$$

The correct value of the PCM is defined as the correct values of the PCMs of the human bodies obtained in Formula 8 aggregated using a maximum value function. As a result, the correct value of the PCM is defined by the following Formula 9. The maximum is used instead of the average in Formula 9 to keep the extrema distinct when extrema are present at proximate pixels.

$${s}_{j}^{*} ( p ) = {max}_{k} {s}_{j , k}^{*} ( p ) \qquad [ Formula 9 ]$$

The definition of the correct value of the PAF will now be described. The PAF represents the part-to-part association degree. The pixels that are between specific parts have unit vectors v. The other pixels have zero vectors. The PAF is defined as the set of these vectors. The correct value of the PAF of the connection c of the kth person for the pixels p inside the image is represented by the following Formula 10, wherein c is the connection between the part j₁ and the part j₂ of the kth person.

$${L}_{c , k}^{*} ( p ) = \{ \begin{matrix}v & p is positioned at c between parts of {k}_{th} person \\ 0 & otherwise\end{matrix} \qquad [ Formula 10 ]$$

The unit vector v is a vector from x_{j1,k} toward x_{j2,k}, and is defined by the following Formula 11.

$$v = \frac{( {x}_{{j}_{2} , k} - {x}_{{j}_{1} , k} )}{{‖ {x}_{{j}_{2} , k} - {x}_{{j}_{1} , k} ‖}_{2}} \qquad [ Formula 11 ]$$

p is defined to be in the connection c of the kth person by the following Formula 12 using a threshold σ1. v marked with a perpendicular symbol is a unit vector perpendicular to v.

$$0 \leq v \cdot ( p - {x}_{{j}_{1} , k} ) \leq {‖ {x}_{{j}_{2} , k} - {x}_{{j}_{1} , k} ‖}_{2} and \vert {v}_{⊥} \cdot ( p - {x}_{{j}_{1} , k} ) \vert \leq {σ}_{l} \qquad [ Formula 12 ]$$

The correct value of the PAF is defined as the value of the average of the correct values of the PAFs of the persons obtained in Formula 10. As a result, the correct value of the PAF is represented by the following Formula 13. n_{c}(p) is the number of nonzero vectors among the pixels p.

$${L}_{c}^{*} ( p ) \frac{1}{{n}_{c} ( p )} {\sum }_{A} {L}_{c , k}^{*} ( p ) \qquad [ Formula 13 ]$$

The model that has been trained using photographed images is then trained using rendered images. The rendered images and the annotations prepared in step S1 are used in the training. For example, the steepest descent method is used. The steepest descent method is one optimization algorithm that searches for the minimum value of a function by using the slope of the function. The first model is prepared by training using rendered images.

### <Preparation of Second Model>

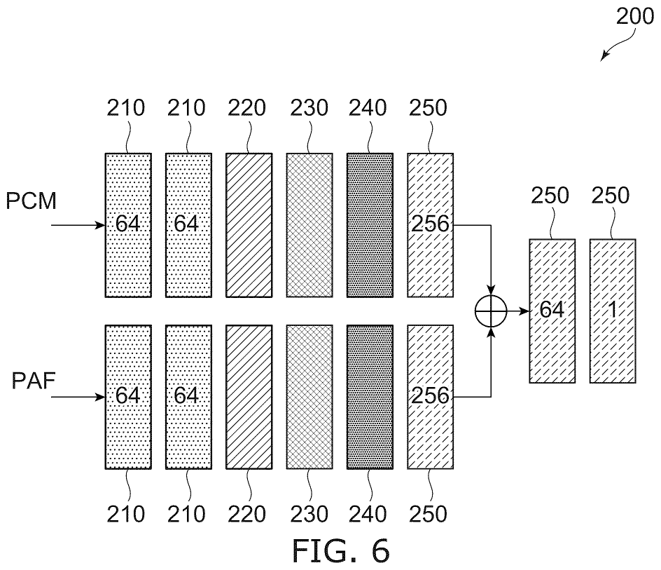

FIG. 6 is a schematic view illustrating a configuration of the second model.

As illustrated in FIG. 6, the second model 200 includes a convolutional layer 210, max pooling 220, a dropout layer 230, a flatten layer 240, and a fully connected layer 250. The numerals in the convolutional layer 210 represent the number of channels. The numerals in the fully connected layer 250 represent the dimensions of the output. The PCM and the PAF, which are the outputs of the first model, are input to the second model 200. When the data of the pose is input from the first model 100, the second model 200 outputs a determination result of whether the data is based on a photographed image or a rendered image.

For example, the PCM that is output from the first model 100 has nineteen channels. The PAF that is output from the first model 100 has thirty-eight channels. When input to the second model 200, the PCM and the PAF are normalized so that the input data has values in the range of 0 to 1. The normalization includes dividing by the maximum values of the values of the PCM and the PAF at the pixels. The maximum value of the PCM and the maximum value of the PAF are acquired from the PCM and the PAF output from the first model 100 when multiple photographed images and multiple rendered images are prepared separately from the data set used in the training.

The normalized PCM and PAF are input to the second model 200. The second model 200 includes a multilayer neural network that includes the convolutional layers 210. The PCM and the PAF each are input to two convolutional layers 210. The output information of the convolutional layer 210 is passed through an activation function. A ramp function (a normalized linear function) is used as the activation function. The output of the ramp function is input to the flatten layer 240, and is processed to be inputtable to the fully connected layer 250.

To suppress overtraining, the dropout layer 230 is located before the flatten layer 240. The output information of the flatten layer 240 is input to the fully connected layer 250, and is output as information having 256 dimensions. The output information is passed through a ramp function as an activation function, and is connected as information having 512 dimensions. The connected information is input once again to the fully connected layer 250 having a ramp function as an activation function. The output information having 64 dimensions is input to the fully connected layer 250. Finally, the output information of the fully connected layer 250 is passed through a sigmoid function, which is an activation function; and the probability that the input to the first model 100 is a photographed image is output. The training device 1 determines that the input to the first model 100 is a photographed image when the output probability is not less than 0.5. The training device 1 determines that the input to the first model 100 is a rendered image when the output probability is less than 0.5.

When training either model, binary cross-entropy is used as the loss function. A loss function fd of the second model 200 is defined by the following Formula 14, wherein Pₙ is the probability that the input to the first model 100 is a photographed image for some image n. N represents all images in the data set. tₙ is the correct label assigned to the input image n. tₙ=1 when n is a photographed image. tₙ=0 when n is a rendered image.

$${f}_{d} = - {\sum }_{n = 1}^{N} \{ {t}_{n} log {P}_{{real}_{n}} + ( 1 - {t}_{n} ) log ( 1 - {P}_{{real}_{n}} ) \} \qquad [ Formula 14 ]$$

Training is performed to minimize the loss function defined in Formula 14. For example, Adam is used as the optimization technique. In the steepest descent method, the same learning rate is used for all of the parameters. In contrast, Adam can update the appropriate weight for each parameter by considering the mean square and average of the gradients. The second model 200 is prepared as a result of the training.

### <Training of First Model and Second Model>

The first model 100 is trained by using the second model 200 that has been prepared. Also, the second model 200 is trained using the first model 100 that has been prepared. The training of the first model 100 and the training of the second model 200 are alternately performed.

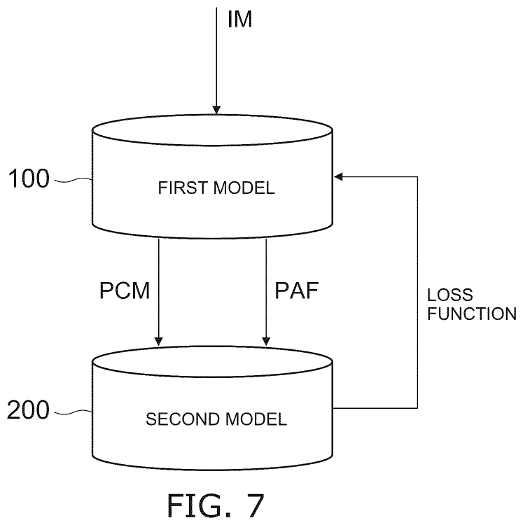

FIG. 7 is a schematic view illustrating a training method of the first and second models.

The image IM is input to the first model 100. The image IM is a photographed image or a rendered image. The first model 100 outputs the PCM and the PAF. The PCM and the PAF each are input to the second model 200. The PAM and the PAF are normalized as described above when input to the second model 200.

The training of the first model 100 will now be described. The first model 100 is trained to reduce the accuracy of the determination by the second model 200. In other words, the first model 100 is trained to deceive the second model 200. For example, the first model 100 is trained so that a rendered image input to the first model 100 causes the first model 100 to output pose data that the second model 200 determines to be a photographed image.

When training the first model 100, the update of the weights of the second model 200 is suspended so that training of the second model 200 is not performed. For example, only rendered images are used as the input to the first model 100. This is to prevent the first model 100 from being trained to deceive the second model 200 by reducing the detection accuracy of photographed images that were already detectable. To train the first model 100 to deceive the second model 200, the correct label is reversed when the PCM and the PAF are input to the second model 200.

The first model 100 is trained to minimize the loss functions of the first and second models 100 and 200. By simultaneously using the loss function of the second model 200 and the loss function of the first model 100, the first model 100 can be prevented from being trained to deceive the second model 200 by not being able to perform the pose detection regardless of the input. From Formulas 7 and 14, a loss function f_{g} of the training phase of the first model 100 is represented by the following Formula 15. λ is a parameter for adjusting the trade-off between the loss function of the first model 100 and the loss function of the second model 200. For example, 0.5 is set as λ.

$${f}_{g} = λ f + {f}_{d} \qquad [ Formula 15 ]$$

Training of the second model 200 will now be described. The second model 200 is trained to increase the accuracy of the determination. In other words, as a result of training the first model 100, the first model 100 outputs pose data that deceives the second model 200. The second model 200 is trained to be able to correctly determine whether the pose data is based on a photographed image or a rendered image.

When training the second model 200, the update of the weights of the first model 100 is suspended so that training of the first model 100 is not performed. For example, both photographed images and rendered images are input to the first model 100. The second model 200 is trained to minimize the loss function defined by Formula 14. Similarly to when generating the second model 200, Adam can be used as the optimization technique.

The training of the first model 100 described above and the training of the second model 200 are alternately performed. The training device 1 stores the trained first model 100 and the trained second model 200 in the storage device 4.

Effects of the first embodiment will now be described.

In recent years, methods that detect the pose of a human body from RGB images that are imaged with video camcorders and the like, depth images that are imaged with depth cameras, etc., are being studied. Also, the utilization of pose detection is being tried in an effort to improve productivity. However, problems exist in that the detection accuracy of the pose in a manufacturing site or the like may be greatly reduced according to the pose of the worker and the environment of the task.

There are many cases where the angle of view, the resolution, etc., are limited for images that are imaged in a manufacturing site. For example, in a manufacturing site, when a camera is arranged not to obstruct the task, it is favorable for the camera to be located higher than the worker. Also, equipment, products, etc., are placed in manufacturing sites, and it is common for a portion of the worker not to be visible. For a conventional method such as OpenPose, etc., the detection of the pose may greatly degrade for images in which the human body is imaged from above, images in which only a portion of the worker is visible, etc. Also, equipment, products, jigs, etc., are present in manufacturing sites. There are also cases where such objects are misdetected as human bodies.

For images in which the worker is imaged from above and images in which a portion of the worker is not visible, it is desirable to sufficiently train the model to increase the detection accuracy of the pose. However, much training data is necessary to train the model. Preparing images by actually imaging the worker from above and performing annotation for each of the images would require an enormous amount of time.

To reduce the time necessary for preparing the training data, it is effective to use a virtual human body model. By using a virtual human body model, images in which the worker is visible from any direction can be easily generated (rendered). Also, the annotation for the rendered images can be easily completed by using skeleton data corresponding to the human body model.

On the other hand, a rendered image has less noise than a photographed image. Noise is fluctuation of pixel values, defects, etc. For example, a rendered image made only by rendering a human body model includes no noise, and is excessively clear compared to a photographed image. Although the rendered image can be provided with texture by texture mapping, even in such a case, the rendered image is clearer than the photographed image. Therefore, there is a problem in that the detection accuracy of the pose of a photographed image is low when the photographed image is input to a model trained using rendered images.

For this problem, according to the first embodiment, the first model 100 for detecting the pose is trained using the second model 200. When pose data is input, the second model 200 determines whether the pose data is based on a photographed image or a rendered image. The first model 100 is trained to reduce the accuracy of the determination by the second model 200. The second model 200 is trained to increase the accuracy of the determination.

For example, the first model 100 is trained so that when a photographed image is input, the second model 200 determines that the pose data is based on a rendered image. Also, the first model 100 is trained so that when a rendered image is input, the second model 200 determines that the pose data is based on a photographed image. As a result, when a photographed image is input, the first model 100 can detect the pose data with high accuracy similarly to when a rendered image used in the training is input. Also, the second model 200 is trained to increase the accuracy of the determination. By alternately performing the training of the first model 100 and the training of the second model 200, the first model 100 can detect the pose data of the human body included in a photographed image with higher accuracy.

To train the second model 200, it is favorable to use a PCM, which is data of the positions of the multiple parts of the human body, and a PAF, which is data of the associations between the parts. The PCM and the PAF have a high association with the pose of the person inside the image. When the training of the first model 100 is insufficient, the first model 100 cannot appropriately output the PCM and the PAF based on rendered images. As a result, the second model 200 tends to determine that the PCM and the PAF output from the first model 100 are based on a rendered image. To reduce the accuracy of the determination by the second model 200, the first model 100 is trained to be able to output a more appropriate PCM and PAF not only for a photographed image, but also for a rendered image. As a result, a favorable PCM and PAF for the detection of the pose are more appropriately output. As a result, the accuracy of the pose detection by the first model 100 can be increased.

It is favorable for the human body model to be imaged from above in at least a portion of the rendered images used to train the first model 100. This is because, in a manufacturing site as described above, cameras may be located higher than the worker so that the task is not obstructed. By using rendered images in which the human body model is imaged from above to train the first model 100, the pose can be detected with higher accuracy for images in which a worker in an actual manufacturing site is visible. “Above” refers not only to directly above the human body model, but also positions higher than the human body model.

### First Modification

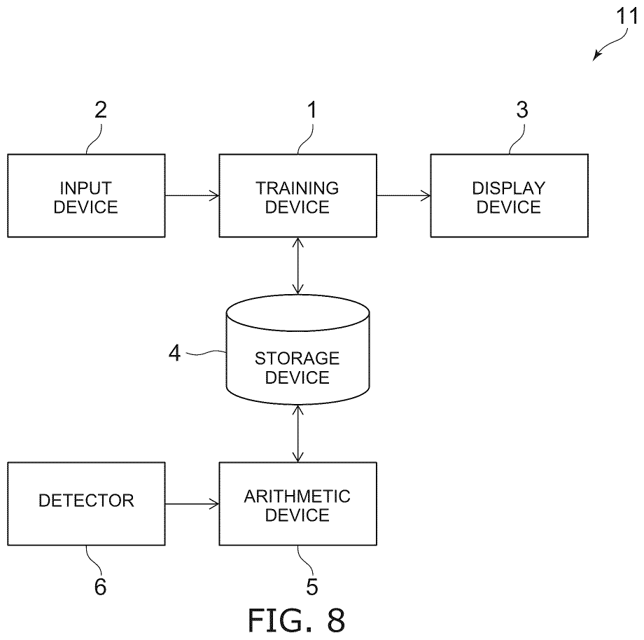

FIG. 8 is a schematic block diagram showing a configuration of a training system according to a first modification of the first embodiment.

As illustrated in FIG. 8, the training system 11 according to the first modification further includes an arithmetic device 5 and a detector 6. The detector 6 is mounted to a person in real space and detects the motion of the person. The arithmetic device 5 calculates positions of each part of the human body at multiple times based on the detected motion, and stores the calculation result in the storage device 4.

For example, the detector 6 includes at least one of an acceleration sensor or an angular velocity sensor. The detector 6 detects the acceleration or angular velocity of parts of the person. The arithmetic device 5 calculates the positions of the parts based on the detection result of the acceleration or angular velocity.

The number of the detectors 6 is appropriately selected according to the number of parts to be discriminated. For example, as illustrated in FIG. 4, ten detectors 6 are used when marking the head, two shoulders, two upper arms, two forearms, and two hands of a person imaged from above. The ten detectors are mounted respectively to portions of the parts of the person in real space to which the ten detectors can be stably mounted. For example, the detectors each are mounted where the change of the shape is relatively small such as the back of the hand, the middle portion of the forearm, the middle portion of the upper arm, the shoulder, the back of the neck, and the periphery of the head; and the position data of these parts is acquired.

The training device 1 refers to the position data of the parts stored in the storage device 4 and causes the human body model to have the same pose as the person in real space. The training device 1 uses the human body model of which the pose is set to generate a rendered image. For example, the person to which the detectors 6 are mounted takes the same pose as the actual task. As a result, the pose of the human body model visible in the rendered image approaches the pose in the actual task.

According to this method, it is unnecessary for a person to designate the positions of the parts of the human body model. Also, the pose of the human body model can be prevented from being a completely different pose from the pose of the person in the actual task. Because the pose of the human body model approaches the pose in the actual task, the detection accuracy of the pose by the first model can be increased.

### Second Embodiment

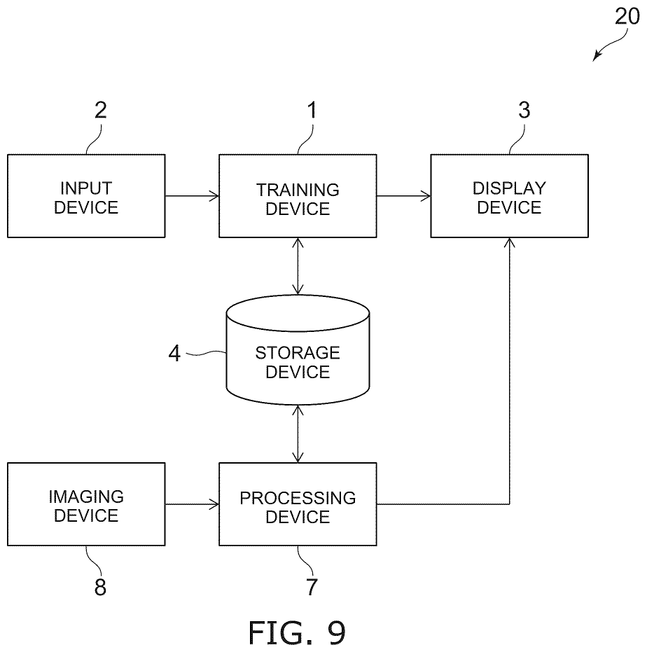

FIG. 9 is a schematic block diagram illustrating a configuration of an analysis system according to a second embodiment.

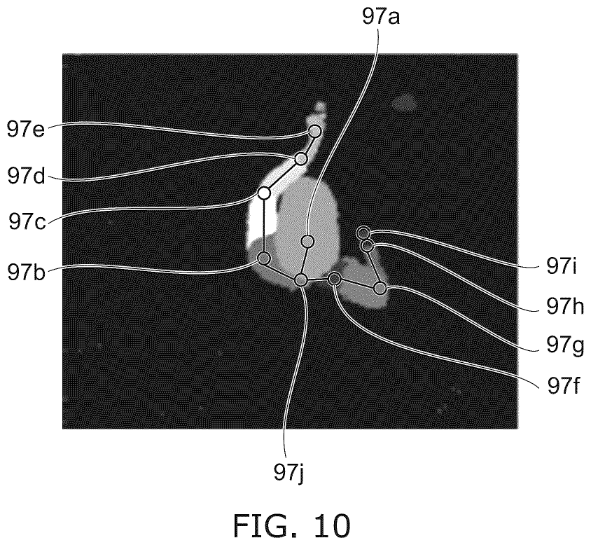

FIGS. 10 to 13 are figures for describing the processing according to the analysis system according to the second embodiment.

The analysis system 20 according to the second embodiment analyzes the motion of a person by using, as a pose detection model, the first model trained by the training system according to the first embodiment. As illustrated in FIG. 9, the analysis system 20 further includes a processing device 7 and an imaging device 8.

The imaging device 8 generates an image by imaging a person (a first person) working in real space. Hereafter, the person that is working and is imaged by the imaging device 8 also is called a worker. The imaging device 8 may acquire a still image or may acquire a video image. When acquiring a video image, the imaging device 8 cuts out still images from the video image. The imaging device 8 stores the images of the worker in the storage device 4.

The worker repeatedly performs a prescribed first task. The imaging device 8 repeatedly images the worker between the start and the end of the first task performed one time. The imaging device 8 stores, in the storage device 4, the multiple images obtained by the repeated imaging. For example, the imaging device 8 images the worker repeating multiple first tasks. As a result, multiple images in which the appearances of the multiple first tasks are imaged are stored in the storage device 4.

The processing device 7 accesses the storage device 4 and inputs, to the first model, an image (a photographed image) in which the worker is visible. The first model outputs pose data of the worker in the image. For example, the pose data includes positions of multiple parts and associations between parts. The processing device 7 sequentially inputs, to the first model, multiple images in which the worker performing the first task is visible. As a result, the pose data of the worker is obtained at each time.

As an example, the processing device 7 inputs an image to the first model and acquires the pose data illustrated in FIG. 10. The pose data includes the positions of each of a centroid 97a of the head, a centroid 97b of the left shoulder, a left elbow 97c, a left wrist 97d, a centroid 97e of the left hand, a centroid 97f of the right shoulder, a right elbow 97g, a right wrist 97h, a centroid 97i of the right hand, and a spine 97j. The pose data also includes data of the bones connecting these elements.

The processing device 7 uses the multiple sets of pose data to generate time-series data of the motion of the part over time. For example, the processing device 7 extracts the position of the centroid of the head from the sets of pose data. The processing device 7 rearranges the position of the centroid of the head according to the time of acquiring the image that is the basis of the pose data. For example, the time-series data of the motion of the head over time is obtained by generating data in which the time and the position are associated and used as one record, and by sorting the multiple sets of data in chronological order. The processing device 7 generates the time-series data for at least one part.

The processing device 7 estimates the period of the first task based on the generated time-series data. Or, the processing device 7 estimates a range of the time-series data based on the motion of one first task.

The processing device 7 stores the information obtained by the processing in the storage device 4. The processing device 7 may output the information to the outside. For example, the information that is output includes the calculated period. The information may include a value obtained by a calculation using the period. In addition to the period, the information may include time-series data, the times of the images used to calculate the period, etc. The information may include a portion of the time-series data of the motion of one first task.

The processing device 7 may output the information to the display device 3. Or, the processing device 7 may output a file including the information in a prescribed format such as CSV, etc. The processing device 7 may transmit the data to an external server by using FTP (File Transfer Protocol), etc. Or, the processing device 7 may insert the data into an external database server by performing database communication and using ODBC (Open Database Connectivity), etc.

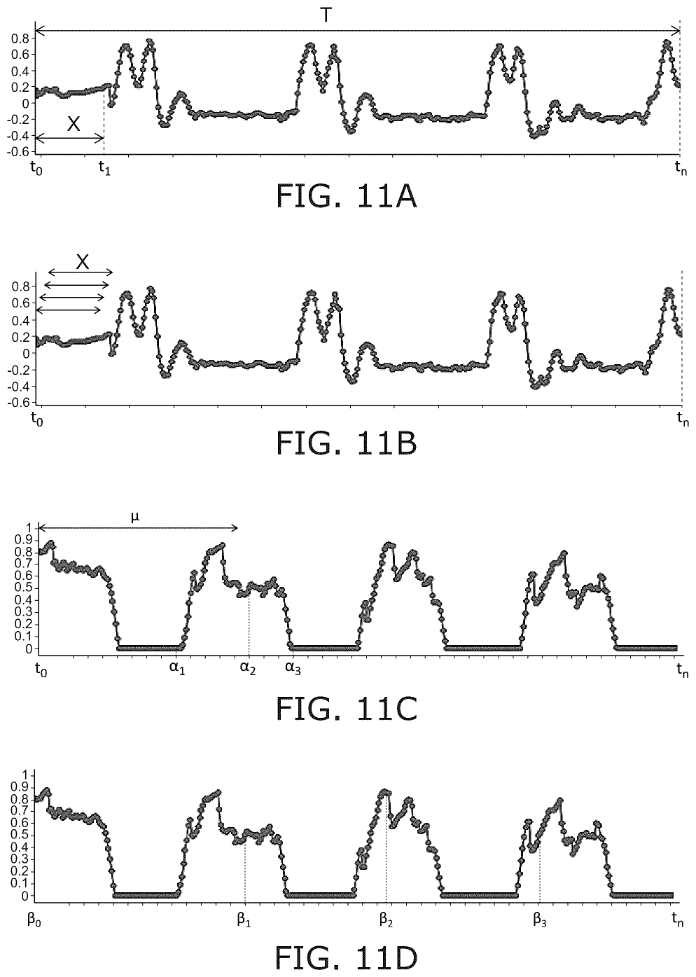

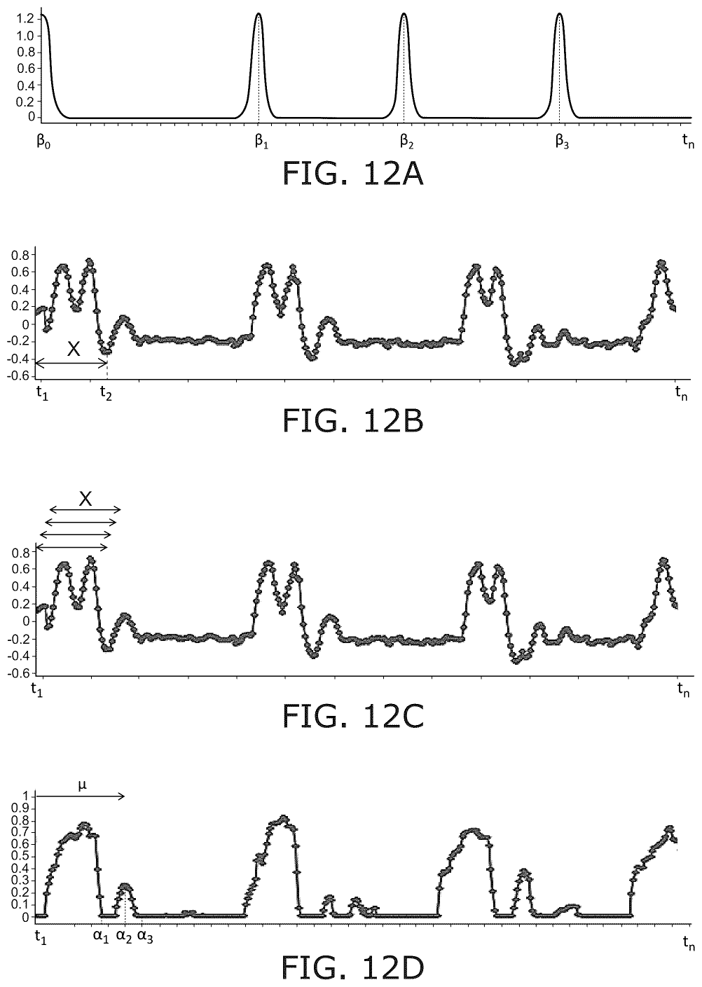

In FIGS. 11A, 11B, 12B, and 12C, the horizontal axis is the time, and the vertical axis is the vertical-direction position (the depth).

In FIGS. 11C, 11D, 12D, and 13A, the horizontal axis is the time, and the vertical axis is the distance. In these figures, a larger distance value indicates that the distance is short between two objects, and the correlation is strong.

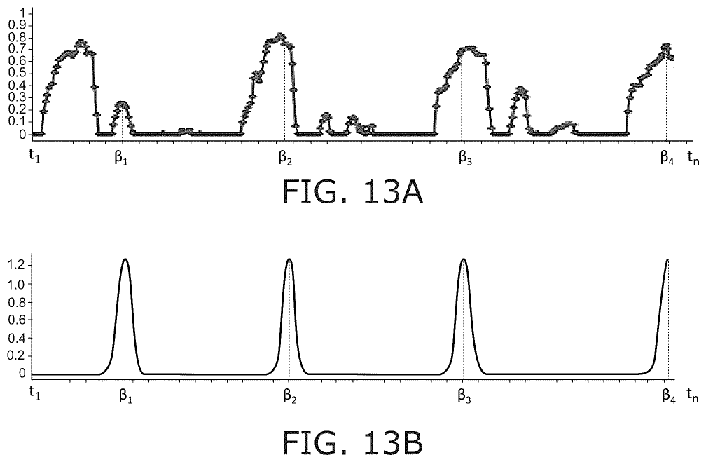

In FIGS. 12A and 13B, the horizontal axis is time, and the vertical axis is a scalar value.

FIG. 11A is an example of time-series data generated by the processing device 7. For example, FIG. 11A is the time-series data of a time length T showing the motion of the left hand of the worker. First, the processing device 7 extracts partial data of a time length X from the time-series data illustrated in FIG. 11A. For example, the time length X is preset by the worker, the manager of the analysis system 20, etc. A value that roughly corresponds to the period of the first task is set as the time length X. The time length T may be preset or may be determined based on the time length X. For example, the processing device 7 inputs, to the first model, the multiple images that are imaged during the time length T, and obtains the pose data. The processing device 7 uses the pose data to generate the time-series data of the time length T.

Separately from the partial data, the processing device 7 extracts the data of the time length X at a prescribed time interval within a time t₀ to a time tₙ in the time-series data of the time length T. Specifically, as illustrated by the arrows of FIG. 11B, for example, the processing device 7 extracts the data of the time length X from the time-series data for each frame over the entirety from the time t₀ to the time tₙ. In FIG. 11B, the durations are illustrated by arrows for only a portion of the extracted data. Thereafter, the information that is extracted by the step illustrated in FIG. 11B is called first comparison data.

The processing device 7 sequentially calculates the distances between the partial data extracted in the step illustrated in FIG. 11A and each of the first comparison data extracted in the step illustrated in FIG. 11B. For example, the processing device 7 calculates the DTW (Dynamic Time Warping) distance between the partial data and the first comparison data. By using the DTW distance, the strength of the correlation can be determined regardless of the length of time of the repeated motion. As a result, the information of the distance of the time-series data for the partial data is obtained at each time. These are illustrated in FIG. 11C. Hereinafter, the information that includes the distance at each time illustrated in FIG. 11C is called first correlation data.

Then, the processing device 7 sets temporary similarity points in the time-series data to estimate the period of the work time of a worker M. Specifically, in the first correlation data illustrated in FIG. 11C, the processing device 7 randomly sets multiple candidate points α₁ to αₘ within the range of a fluctuation time N referenced to a time after a time μ has elapsed from the time to. In the example illustrated in FIG. 11C, three candidate points are randomly set. For example, the time u and the fluctuation time N are preset by the worker, the manager, etc.

The processing device 7 generates data of normal distributions having peaks respectively at the candidate points α₁ to αₘ that are randomly set. Then, a cross-correlation coefficient (a second cross-correlation coefficient) with the first correlation data illustrated in FIG. 11C is determined for each normal distribution. The processing device 7 sets the temporary similarity point to be the candidate point with the highest cross-correlation coefficient. For example, the temporary similarity point is set to the candidate point α₂ illustrated in FIG. 11C.

Based on the temporary similarity point (the candidate point α₂), the processing device 7 again randomly sets the multiple candidate points α₁ to αₘ within the range of the fluctuation time N referenced to a time after the time μ has elapsed. Multiple temporary similarity points β₁ to βₖ are set between the time t₀ to the time tₙ as illustrated in FIG. 11D by repeatedly performing this step until the time tn.

As illustrated in FIG. 12A, the processing device 7 generates data that includes multiple normal distributions having peaks at respectively the temporary similarity points β₁ to βₖ. Hereinafter, the information that includes the multiple normal distributions illustrated in FIG. 12A is called second comparison data. The processing device 7 calculates a cross-correlation coefficient (a first cross-correlation coefficient) between the first correlation data illustrated in FIGS. 11C and 11D and the second comparison data illustrated in FIG. 12A.

The processing device 7 performs steps similar to those of FIGS. 11A to 12A for other partial data as illustrated in FIGS. 12B to 12D, FIG. 13A, and FIG. 13B. Only the information at and after a time t₁ is illustrated in FIGS. 12B to 13B.

For example, as illustrated in FIG. 12B, the processing device 7 extracts the partial data of the time length X between the time t₁ and a time t₂. Continuing, the processing device 7 extracts multiple sets of first comparison data of the time length X as illustrated in FIG. 12C. The processing device 7 generates the first correlation data as illustrated in FIG. 12D by calculating the distances between the partial data and the multiple sets of first comparison data.

As illustrated in FIG. 12D, the processing device 7 extracts a temporary similarity point β by randomly setting the multiple candidate points α₁ to αₘ referenced to a time after the time u has elapsed from the time to. By repeating this extraction, the multiple temporary similarity points β₁ to βₖ are set as illustrated in FIG. 13A. Then, as illustrated in FIG. 13B, the processing device 7 generates the second comparison data based on the temporary similarity points β₁ to βₖ and calculates the cross-correlation coefficient between the first correlation data illustrated in FIGS. 12D and 13A and the second comparison data illustrated in FIG. 13B.

The processing device 7 also calculates the cross-correlation coefficient for the partial data at and after the time t₂ by repeating the steps described above. Subsequently, the processing device 7 extracts, as the true similarity points, the temporary similarity points β₁ to βₖ for which the highest cross-correlation coefficient is obtained. The processing device 7 obtains the period of the first task of the worker by calculating the time interval between the true similarity points. For example, the processing device 7 can determine the average time between the true similarity points adjacent to each other along the time axis, and use the average time as the period of the first task. Or, the processing device 7 extracts the time-series data between the true similarity points as the time-series data of the motion of one first task.

Here, an example is described in which the period of the first task of the worker is analyzed by the analysis system 20 according to the second embodiment. The applications of the analysis system 20 according to the second embodiment are not limited to the example. For example, the analysis system 20 can be widely applied to the analysis of the period of a person that repeatedly performs a prescribed motion, the extraction of time-series data of one motion, etc.

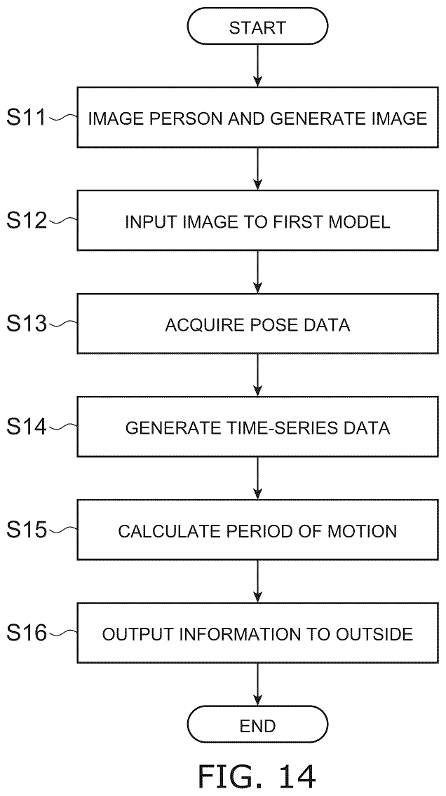

FIG. 14 is a flowchart illustrating the processing according to the analysis system according to the second embodiment.

The imaging device 8 generates an image by imaging a person (step S11). The processing device 7 inputs the image to the first model (step S12) and acquires pose data (step S13). The processing device 7 uses the pose data to generate time-series data related to the parts (step S14). The processing device 7 calculates the period of the motion of the person based on the time-series data (step S15). The processing device 7 outputs the information based on the calculated period to the outside (step S16).

According to the analysis system 20, the period of a prescribed motion that is repeatedly performed can be automatically analyzed. For example, the period of a first task of a worker in a manufacturing site can be automatically analyzed. Therefore, recording and/or reporting performed by the worker themselves, observation work and/or period measurement by an engineer for work improvement, etc., are unnecessary. The period of the task can be easily analyzed. Also, the period can be determined with higher accuracy because the analysis result is independent of the experience, the knowledge, the judgment, etc., of the person performing the analysis.

Also, when analyzing, the analysis system 20 uses the first model trained by the training system according to the first embodiment. According to the first model, the pose of the person that is imaged can be detected with high accuracy. By using the pose data output from the first model, the accuracy of the analysis can be increased. For example, the accuracy of the estimation of the period can be increased.

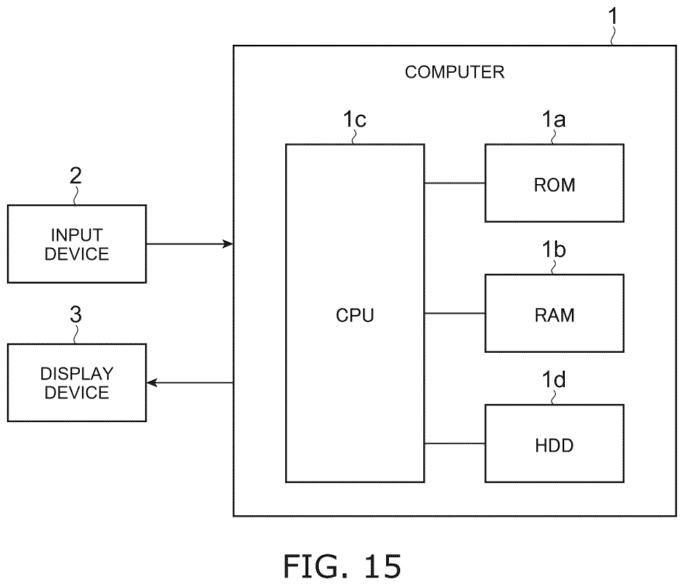

FIG. 15 is a block diagram illustrating a hardware configuration of the system.

For example, the training device 1 is a computer and includes ROM (Read Only Memory) 1a, RAM (Random Access Memory) 1b, a CPU (Central Processing Unit) 1c, and a HDD (Hard Disk Drive) 1d.

The ROM 1a stores programs controlling the operations of the computer. The ROM 1a stores programs necessary for causing the computer to realize the processing described above.

The RAM 1b functions as a memory region where the programs stored in the ROM 1a are loaded. The CPU 1c includes a processing circuit. The CPU 1c reads a control program stored in the ROM 1a and controls the operation of the computer according to the control program. Also, the CPU 1c loads various data obtained by the operation of the computer into the RAM 1b. The HDD 1d stores information necessary for reading and information obtained in the reading process. For example, the HDD 1d functions as the storage device 4 illustrated in FIG. 1.

Instead of the HDD 1d, the training device 1 may include an eMMC (embedded MultiMediaCard), a SSD (Solid State Drive), a SSHD (Solid State Hybrid Drive), etc.

A hardware configuration similar to FIG. 15 is applicable also to the arithmetic device 5 of the training system 11 and the processing device 7 of the analysis system 20. Or, one computer may function as the training device 1 and the arithmetic device 5 in the training system 11. One computer may function as the training device 1 and the processing device 7 in the analysis system 20.

By using the training device, the training system, the training method, and the trained first model described above, the pose of a human body inside an image can be detected with higher accuracy. Also, similar effects can be obtained by using a program to cause a computer to operate as the training device.

Also, by using the processing device, the analysis system, and the analysis method described above, time-series data can be analyzed with higher accuracy. For example, the period of the motion of the person can be determined with higher accuracy. Similar effects can be obtained by using a program to cause a computer to operate as the processing device.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another recording medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions, and are within the scope of the inventions described in the claims and their equivalents. Also, the embodiments above can be implemented in combination with each other.

What is claimed is:

1. A training device,
the training device training:
a first model outputting pose data of a pose of a human body included in a photographed image or a rendered image when the photographed image or the rendered image is input, an actual person being visible in the photographed image, the rendered image being rendered using a human body model, the human body model being virtual; and
a second model determining whether the pose data is based on one of the photographed image or the rendered image when the pose data is input,
the first model being trained to reduce an accuracy of the determination by the second model,
the second model being trained to increase the accuracy of the determination by the second model.

2. The training device according to claim 1, wherein
an update of the second model is suspended when training the first model, and
an update of the first model is suspended when training the second model.

3. The training device according to claim 1, wherein
training of the first model and training of the second model are performed alternately.

4. The training device according to claim 1, wherein
the first model is trained using a plurality of the rendered images, and
at least a portion of the plurality of rendered images is an image of a portion of the human body model rendered from above.

5. The training device according to claim 1, wherein
the pose data includes:
data of positions of a plurality of parts of the human body; and
data of an association between the parts.

6. A processing device,
the processing device acquiring time-series data of a change of a pose over time by inputting a plurality of work images to the first model trained by the training device according to claim 1,
a person when working being visible in the plurality of work images.

7. A training method,
the training method training:
a first model outputting pose data of a pose of a human body included in a photographed image or a rendered image when the photographed image or the rendered image is input, an actual person being visible in the photographed image, the rendered image being rendered using a human body model, the human body model being virtual; and
a second model determining whether the pose data is based on one of the photographed image or the rendered image when the pose data is input,
the first model being trained to reduce an accuracy of the determination by the second model,
the second model being trained to increase the accuracy of the determination by the second model.

8. A pose detection model, comprising:
the first model trained by the training method according to claim 7.

9. A non-transitory computer-readable storage medium storing a program,
the program causing a computer to train:
a first model outputting pose data of a pose of a human body included in a photographed image or a rendered image when the photographed image or the rendered image is input, an actual person being visible in the photographed image, the rendered image being rendered using a human body model, the human body model being virtual; and
a second model determining whether the pose data is based on one of the photographed image or the rendered image when the pose data is input,
the first model being trained to reduce an accuracy of the determination by the second model,
the second model being trained to increase the accuracy of the determination by the second model.
